(19) United States
(12) Patent Application Publication
(10) Pub. No.: US 2012/0205595 A1
(43) Pub. Date: Aug. 16, 2012

(54) ELECTRODE MATERIALS AND PROCESS FOR PRODUCING THEM

(75) Inventors: Martin SCHULZ-DOBRICK, Mannheim (DE); Bastian EWALD, Ludwigshafen (DE); Hartmut HIBST, Schriesheim (DE); Jordan Keith LAMPERT, Ludwigshafen (DE)

(73) Assignee: BASF SE, Ludwigshafen (DE)

(21) Appl. No.: 13/370,927

(22) Filed: Feb. 10, 2012

Related U.S. Application Data
(60) Provisional application No. 61/442,370, filed on Feb. 14, 2011.

(51) Int. Cl. H01B 1/06; H01M 4/583

(52) U.S. Cl. 252/507; 252/182.1; 252/506; 252/508

(57) ABSTRACT

Process for producing electrode materials, wherein
(a) (A) iron or at least one iron compound in which Fe is present in the oxidation state zero, +2 or +3,
   (B) silicon or at least one silicon compound selected from among silicon halides, silicon carbide, SiO, silica gels, silicic acid and silanes having at least one alkyl group or at least one alkoxy group per molecule,
   (C) at least one lithium compound,
   (D) at least one carbon source which can be a separate carbon source or at the same time at least one iron compound (A) or silicon compound (B) or lithium compound (C),
   (E) optionally at least one reducing agent,
   (F) optionally at least one compound which has a transition metal or metal other than iron of groups 3 to 13 of the Periodic Table of the Elements,
   (G) optionally water or at least one organic solvent, are mixed with one another,
(b) the mixture thus obtained is dried convectively and
(c) thermally treated at temperatures in the range from 400 to 1200° C.

The present invention relates to a process for producing electrode materials, wherein
(a) (A) iron or at least one iron compound in which Fe is present in the oxidation state zero, +2 or +3,
   (B) silicon or at least one silicon compound selected from among silicon halides, silicon carbide, SiO, silica gels, silicic acid and silanes having at least one alkyl group or at least one alkoxy group per molecule,
   (C) at least one lithium compound,
   (D) at least one carbon source which can be a separate carbon source or at the same time at least one iron compound (A) or silicon compound (B) or lithium compound (C),
   (E) optionally at least one reducing agent,
   (F) optionally at least one compound which has a transition metal or metal other than iron of groups 3 to 13 of the Periodic Table of the Elements,
   (G) optionally water or at least one organic solvent, are mixed with one another,
(b) the mixture thus obtained is dried convectively and
(c) thermally treated at temperatures in the range from 400 to 1200° C.

The present invention further relates to electrode materials which can be obtained from the process of the invention. The present invention further relates to the use of electrode materials according to the invention in electrochemical cells.

In the search for advantageous electrode materials for batteries which utilize lithium ions as conductive species, numerous materials, for example lithium-comprising spinels, mixed oxides, for example lithiated nickel-manganese-cobalt oxides and lithium-iron phosphates, have hitherto been proposed.

Many mixed oxides are sensitive to oxidation. In addition, the production of cathode materials based on mixed oxides and also spinels generally requires a plurality of stages: a precursor, for example a mixed carbonate or a mixed hydroxide, is firstly prepared by precipitation. The precursor is lithiated and calcined in the next step in order to obtain the mixed oxide or the spinel. This material then has to be mixed with carbon in an electrically conductive form, for example with carbon black. This process is very inconvenient.

It is therefore an object of the invention to provide a process for producing electrode materials, which is simple, requires very few steps and provides access to chemically insensitive electrode materials. A further object was to provide chemically insensitive electrode materials which can be produced with an ideally low outlay. A further object was to provide electrochemical cells which have, overall, advantageous use properties, for example a uniform chemical composition, a regular spherical shape, suitable porosities, suitable conductivities and good Li ion diffusivity.

We have accordingly found the process defined at the outset, hereinafter also referred to as process of the invention.

To carry out the process of the invention, a plurality of the starting materials, preferably all participating starting materials, are mixed in a plurality of or preferably in one operation in step (a). Suitable vessels for mixing are, for example, stirred tanks and stirred flasks.

The starting materials are described in more detail below.

As starting material (A), use is made of at least one iron or iron compound, hereinafter also referred to as iron compound (A) in which iron, i.e. Fe, is present in the oxidation state zero, +2 or +3. These compounds are preferably inorganic iron compounds, for example iron oxide such as FeO, Fe₂O₃ or Fe₃O₄, iron hydroxide, for example Fe(OH)₃, basic iron hydroxide, also described as FeOOH, FeCO₃, water-comprising iron oxide, also described as FeO.aq or Fe₂O₃.aq, or water-soluble iron salts such as FeSO₄, Fe₂(SO₄)₃, iron(II) acetate, iron nitrate, in particular Fe(NO₃)₃, iron halide, in particular iron(II) chloride and iron(III) chloride, iron lactate, iron acetylacetonate and iron pentacarbonyl, also basic iron carbonate and iron citrate. For the purposes of the present invention, carboxylic acid salts of iron are considered to be inorganic iron compounds. For the purposes of the present invention, the respective hydrate complexes, i.e., for example, FeSO₄.4 H₂O, FeCl₃.6 H₂O and Fe(C₆H₅O₇).H₂O, are also included.

In an embodiment of the present invention, at least two iron compounds of which at least one, preferably at least two, has/have Fe in the oxidation state +2 or +3 are selected as starting material (A).

In an embodiment of the present invention, at least three iron compounds which all have Fe in the oxidation state +2 or +3 are selected as starting material (A).

In another embodiment of the present invention, precisely one iron compound in which Fe is present in the oxidation state +2 or +3, in particular +3, is selected as starting material (A).

Starting material (A) can be used, for example, as aqueous solution, as aqueous suspension or as powder, for example as powder having an average particle diameter in the range from 50 to 750 nm, preferably in the range from 100 to 500 nm (number average). In another embodiment, starting material (A) is used as aqueous suspension, with the average particle diameter of the suspended particles being in the range from 50 nm to 750 nm, preferably in the range from 100 to 500 nm (number average).

In an embodiment of the present invention, a mixed compound in which Fe and at least one metal M are present, for example Fe_{1-y}M_{y}O (with divalent M), Fe_{1-y}M_{y}O_{1+y/2} (with trivalent M), Fe_{1-y}M_{y}O_{1+y} (with tetravalent M), Fe_{1-y}M_{y}CO₃ (with divalent M) or Fe_{1-y}M_{y}CO₃(OH)_{y} (with trivalent M), is selected as starting material (A).

As starting material (B), selection is made of silicon or at least one silicon compound, hereinafter also referred to as silicon compound (B), selected from among silanes having at least one alkyl group or at least one alkoxy group per molecule, silicon halides, silicon oxides, silicon carbide and silicic acid. Preferred silanes are those of the general formula (I)

Si(R¹)ᵣ(X¹)ₛHₜ (I)

where the variables are selected as follows:
the radicals R¹ can be identical or different and are selected from among phenyl and preferably C₁-C₁₀-alkyl, cyclic or linear, for example methyl, ethyl, n-propyl, isopropyl, n-butyl, isobutyl, sec-butyl, tert-butyl, n-pentyl, cyclopentyl, isoamyl, isopentyl, n-hexyl, isohexyl, cyclohexyl and 1,-3-dimethylbutyl, preferably n-C₁-C₆-alkyl, particularly preferably methyl, ethyl, n-propyl, isopropyl and very particularly preferably methyl or ethyl. When a material has a plurality of alkoxy groups per molecules, the radicals R¹ can be different or preferably identical and be selected from among the abovementioned C₁-C₆-alkyl radicals,
the radicals X¹ can be identical or different and are selected from among halogen, phenoxy groups and alkoxy groups, preferably of the formula OR¹, in particular methoxy and ethoxy, where halogen is preferably bromine and particularly preferably chlorine,
r, s are selected from among integers in the range from 0 to 4,
t is selected from among integers in the range from 0 to 3,
where r+s+t=4 applies and
at least one of the inequalities
r≠0
s≠0
is satisfied.

In an embodiment of the present invention, silicon compound (B) is selected from among compounds of the general formula Si(OR¹)₄, where the radicals R¹ can be different or preferably identical and are selected from among phenyl and C₁-C₁₀-alkyl, with particular preference being given to Si(OCH₃)₄ and Si(OC₂H₅)₄.

As silicic acid, it is possible to select, for example, orthosilicic acid or salts thereof, for example water glass, in particular sodium water glass, potassium water glass and in particular lithium water glass. For the purposes of the present invention, the term silicon oxide also encompasses water-comprising silicon oxides, SiO₂ gels and SiO₂ sols.

In an embodiment of the present invention, silicon compound (B) is selected from among SiO, SiO₂ gels and SiO₂ colloids; the latter are, for the purposes of the present invention, also referred to as colloidal solutions.

SiO₂ gels, SiO₂ sols and SiO₂ colloids are not compounds having a defined stoichiometry but in the case of identical physical properties should each be considered to be a single compound.

In an embodiment of the present invention, two or more silicon compounds (B) are selected as starting material (B). In another embodiment of the present invention, precisely one silicon compound (B) is selected.

As starting material (C), use is made of at least one lithium compound, also referred to as lithium compound (C), preferably at least one inorganic lithium compound. Examples of suitable inorganic lithium compounds are lithium halides, for example lithium chloride, also lithium sulfate, lithium acetate, lithium silicates, for example lithium orthosilicate, lithium metasilicate, lithium water glass, also LiOH, Li₂CO₃, Li₂O and LiNO₃; with preference being given to lithium silicates, Li₂SO₄, LiOH, Li₂CO₃, Li₂O and LiNO₃. The lithium compound can comprise water of crystallization, for example LiOH.×H₂O, in particular LiOH.H₂O.

In a specific embodiment of the present invention, lithium silicate or lithium water glass is selected as silicon compound (B) and lithium compound (C), i.e. lithium silicate or lithium water glass can simultaneously serve as silicon compound (B) and as lithium compound (C).

As starting material (D), use is made of at least one carbon source, also referred to as carbon source (D) for short, which can be a separate carbon source or at the same time be at least one iron compound (A) or silicon compound (B) or lithium compound (C).

For the purposes of the present invention, the term separate carbon source (D) means that a further starting material which is selected from among elemental carbon in a modification which conducts electric current or a compound which decomposes into carbon in the thermal treatment in step (c) and is different from iron compound (A) and silicon compound (B) and lithium compound (C) is used.

A suitable carbon source (D) is, for example, carbon in a modification which conducts electric current, i.e., for example, carbon black, graphite, graphene, expanded graphite, carbon nanotubes or activated carbon.

Further suitable carbon sources (D) are compounds of carbon which are decomposed into carbon in the thermal treatment in step (c). For example, synthetic and natural polymers, unmodified or modified, are suitable. Examples of synthetic polymers are polyolefins, for example polyethylene and polypropylene, also polyacrylonitrile, polybutadiene, polystyrene and copolymers of at least two comonomers selected from among ethylene, propylene, styrene, (meth)acrylonitrile and 1,3-butadiene. Polyisoprene and polyacrylates are also suitable. Particular preference is given to polyacrylonitrile.

For the purposes of the present invention, the term polyacrylonitrile encompasses not only polyacrylonitrile homopolymers but also copolymers of acrylonitrile with 1,3-butadiene or styrene. Preference is given to polyacrylonitrile homopolymers.

For the purposes of the present invention, the term polyethylene encompasses not only homopolyethylene but also copolymers of ethylene comprising at least 50 mol % of ethylene in copolymerized form and up to 50 mol % of at least one further comonomer, for example α-olefins such as propylene, butylene (1-butene), 1-hexene, 1-octene, 1-decene, 1-dodecene, 1-pentene, also isobutene, vinylaromatics such as styrene, also (meth)acrylic acid, vinyl acetate, vinyl propionate, C₁-C₁₀-alkyl esters of (meth)acrylic acid, in particular methyl acrylate, methyl methacrylate, ethyl acrylate, ethyl methacrylate, n-butyl acrylate, 2-ethylhexyl acrylate, n-butyl methacrylate, 2-ethylhexyl methacrylate, also maleic acid, maleic anhydride and itaconic anhydride. Polyethylene can be HDPE or LDPE.

For the purposes of the present invention, the term polypropylene encompasses not only homopolypropylene but also copolymers of propylene comprising at least 50 mol % of propylene in copolymerized form and up to 50 mol % of at least one further comonomer, for example ethylene and α-olefins such as butylene, 1-hexene, 1-octene, 1-decene, 1-dodecene and 1-pentene. Polypropylene is preferably isotactic or essentially isotactic polypropylene.

For the purposes of the present invention, the term polystyrene encompasses not only homopolymers of styrene but also copolymers with acrylonitrile, 1,3-butadiene, (meth)acrylic acid, C₁-C₁₀-alkyl esters of (meth)acrylic acid, divinylbenzene, in particular 1,3-divinylbenzene, 1,2-diphenylethylene and α-methylstyrene.

Further suitable synthetic polymer is polyvinyl alcohol.

Natural polymers suitable as carbon source (D) are, for example, oligosaccharides and polysaccharides, in particular starches, for example corn starch and potato starch, and cellulose. Further suitable natural polymers are vegetable, animal thickeners and gelling agents: gelatins, collagens, alginates (e.g. agar agar), pectins, gum arabic, oligosaccharides and polysaccharides, guar kernel flour and carob flour. Amylose and amylopectin are also suitable.

Modified natural polymers are also suitable. For the purposes of the present invention, these are natural polymers modified by polymer-analogous reaction. Suitable polymer-analogous reactions are, in particular, esterification and etherification. Preferred examples of modified natural polymers are starch etherified with methanol, acetylated starch, acetylcellulose, phosphated starch and sulfated starch.

Relatively nonvolatile low molecular weight organic compounds are also suitable as carbon source (D). Suitable compounds are, in particular, compounds which do not vaporize but instead decompose at temperatures in the range from 400 to 1200° C., for example as solid or in the melt. Examples are dicarboxylic acids, for example phthalic acid, isophthalic acid, terephthalic acid, tartaric acid, citric acid, also monosaccharides having from 3 to 7 carbon atoms per molecule, for example trioses, tetroses, pentoses, hexoses and heptoses, and condensates of monosaccharides, for example disaccharides, trisaccharides, oligosaccharides and polysaccharides, in particular lactose, glucose and fructose.

Further examples of low molecular weight organic compounds as carbon source (D) are urea and its relatively nonvolatile condensates biuret, melamine, melam (N2-(4,6-diamino-1,3,5-triazin-2-yl)-1,3,5-triazine-2,4,6-triamine) and melem (1,3,4,6,7,9,9b-heptaazaphenalene-2,5,8-triamine).

Further examples of carbon sources (D) are salts, preferably iron salts, ammonium salts and alkali metal salts, particularly preferably iron, ammonium or lithium salts, of organic acids, for example acetates, propionates, lactates, citrates, tartrates, acetylacetonates, benzoates, butyrates. Particularly preferred examples are ammonium acetate, lithium ammonium tartrate, lithium hydrogentartrate, potassium sodium tartrate, lithium hydrogentartrate, lithium ammonium tartrate, lithium tartrate, lithium citrate, ammonium citrate, iron acetate, lithium acetate or lithium lactate.

In an embodiment of the present invention, at least two carbon sources (D), for example sugar and starch, or starch and at least one polyolefin, or sugar and iron lactate and at least one polyolefin, are selected. The choice of at least two carbon sources (D) in many cases enables an improved morphology of electrode material produced according to the invention to be achieved.

In a specific embodiment of the present invention, lithium acetate, lithium lactate or lithium hydrogentartrate is selected as carbon source (D) and lithium compound (C), i.e. lithium compound (C) lithium acetate, lithium lactate or lithium hydrogentartrate can simultaneously serve as carbon source (D).

In a specific embodiment of the present invention, silicon carbide (SiC) or a silane having at least one organic substituent is selected as carbon source (D) and silicon compound (B), i.e. silicon carbide or silane having at least one organic substituent can simultaneously serve as carbon source (D) and as silicon compound (B).

In a specific embodiment of the present invention, iron acetate, iron acetylacetonate, iron lactate or iron tartrate is selected as carbon source (D) and iron compound (A), i.e. the iron compound (A) iron acetate, iron lactate, iron tartrate can simultaneously serve as carbon source (D).

As starting material (E), it is possible to use a reducing agent, also referred to as reducing agent (E) for short. As reducing agent (E), it is possible to use gaseous, liquid or solid substances which under the conditions of step (a) or (c) convert iron, if necessary, into the oxidation state +2.

In an embodiment of the present invention, a metal, for example nickel or manganese, is selected as solid reducing agent (E).

As gaseous reducing agents (E), it is possible to use, for example, hydrogen or carbon monoxide.

In an embodiment of the present invention, a natural or synthetic polymer which can simultaneously serve as carbon source (D) and as reducing agent (E), for example polyvinyl alcohol, is selected.

In an embodiment of the present invention, a compound which can simultaneously serve as reducing agent (E), is selected as iron compound (A), silicon compound (B) or lithium compound (C).

In a specific embodiment of the present invention, SiO is selected as silicon compound (B) and reducing agent (E), i.e. silicon compound (B) SiO can simultaneously serve as reducing agent (E).

4 LiOH+2 Fe³⁺OOH+1Si²⁺O+1 SiO₂→2 Li₂FeSi⁴⁺O₄+3 H₂O

If iron or iron pentacarbonyl is used as reducing agent and iron source, the equation is, for example,

2 LiOH+1/3 Fe⁰+2/3 Fe³⁺+SiO₂→Li₂FeSiO₄+H₂O

In an embodiment of the present invention, no reducing agent (E) which is gaseous at room temperature is used.

In an embodiment of the present invention, no reducing agent (E) is used.

As starting material (F), it is possible to use at least one further compound which has a transition metal or metal other than iron of the groups 3 to 13 of the Periodic Table of the Elements, also referred to as compound (F) for short.

In an embodiment of the present invention, compound (F) is selected from among transition metal compound (F) and aluminum compounds (F). Here, one or more transition metals from the first period of the transition metals is/are preferably selected as transition metal. Transition metal compound (F) is particularly preferably selected from among compounds of Ti, V, Cr, Mn, Co, Ni, Cu and Zn. Aluminum compounds are also preferred.

Compound (F) can be anhydrous or comprise water. Transition metal cation or aluminum cation in compound (F) can be present in complexed form, for example as hydrate complex, or be uncomplexed.

Compound (F) can be a salt, for example a halide, in particular chloride, also nitrate, carbonate, sulfate, oxide, hydroxide, acetate, citrate, tartrate or salts having various anions. Salts are preferably selected from among oxides, carbonates, hydroxides and nitrates, basic or neutral. Very particularly preferred examples of compounds (F) are oxides, hydroxides and carbonates.

In an embodiment of the present invention, compound (F) can act as one or the only carbon source (D); examples which may be mentioned are nickel acetate, cobalt acetate, zinc acetate and manganese(II) acetate.

In an embodiment of the present invention, compound (F) can act as one or the only reducing agent (E). Examples which may be mentioned are manganese(II) acetate, MnCO₃, MnSO₄, MnH₂, NiH₂, manganese tartrate and nickel tartrate.

In an embodiment of the present invention, one or more solvents, for example one or more organic solvents (G) and/or water, can be added in step (a). For the present purposes, organic solvents (G) are materials which are liquid at the temperature of step (a) of the process of the invention and have at least one C—H bond per molecule.

In one variant, water and an organic solvent (G) are added. Examples of suitable organic solvents (G) are, in particular, halogen-free organic solvents (G) such as methanol, ethanol, isopropanol or n-hexane, cyclohexane, acetone, ethyl acetate, diethyl ether and diisopropyl ether.

Preference is given to water.

Without attaching prominence to a particular theory, it is possible that certain organic solvents (G) such as secondary or primary alkanols can also act as reducing agent (E).

In addition, it is possible for certain organic solvents (G) to act at least partly as carbon source (D).

In an embodiment of the present invention, one or more additives, for example one or more surfactants which may be nonionic, anionic, zwitterionic or cationic, can be added during mixing. Preference is given to using one or more nonionic surfactants or one or more anionic surfactants, for example surfactants having one or more carboxylic acid groups in the form of the sodium or potassium salt.

If a cationic surfactant is to be used, it is possible to select, for example, ammonium salts whose counterion is borate, phosphate or sulfate. In a particular embodiment, use is made of one or more nonionic surfactants selected from among polyfunctional alcohols, polyfunctional ethers and in particular alkoxylated alcohols or alkoxylated amines, in particular multiply ethoxylated fatty alcohols or multiply ethoxylated ethylenediamine.

The mixing in step (a) can be carried out, for example, by stirring together one or more suspensions or solutions of the starting materials (A) to (D) and optionally (E), (F) and (G). Compounding to form a paste is also possible. It is also possible to mix solid starting materials intimately with one another, for example by joint milling, and use them as powder.

In an embodiment of the present invention, the mixing in step (a) is carried out at temperatures in the range from 0 to 200° C., preferably at temperatures in the range from room temperature to 100° C., preferably at no more than 90° C.

In an embodiment of the present invention, the mixing in step (a) is carried out at atmospheric pressure. In other embodiments, the mixing is carried out at superatmospheric pressure, for example at from 1.1 to 20 bar. In other embodiments, the mixing in step (a) is carried out under reduced pressure, for example at from 10 mbar to 990 mbar.

The mixing in step (a) can be carried out over a period in the range from five minutes to 12 hours, preferably from 30 minutes to 4 hours, particularly preferably from 45 minutes to 2 hours.

In an embodiment of the present invention, the mixing in step (a) is carried out in one stage.

In another embodiment, the mixing in step (a) is carried out in two or more stages. Thus, it is possible, for example, firstly to dissolve or suspend iron compound (A) and lithium compound (C) together in water, then mix with silicon compound (B) and carbon source (D) and then optionally mix with reducing agent (E) and/or compound (F).

Step (a) gives a mixture of at least one iron compound (A), at least one silicon compound (B), at least one lithium compound (C), at least one carbon source (D), optionally reducing agent (E), optionally compound (F) and preferably water and/or at least one organic solvent (G) in paste-like form, as water-comprising powder, as suspension or as solution.

In an embodiment of the present invention, at least one compound which is suitable for forming a precursor of a doped electrode material is added as additive. For the purposes of the present invention, doped electrode materials are electrode materials which comprise up to a maximum of 3 atom percent, based on the total metal content of the respective electrode material produced according to the invention, of metal atoms or nonmetal atoms, with preferred nonmetals being fluorine, phosphorus and boron. Examples of suitable compounds are salts and other compounds of main group and transition metals, in particular their fluorides, reactive compounds of main group and transition metals, semimetals and nonmetals, in particular titanium alkoxides, metatitanic acids, borates and boric acid derivatives, in particular boron alkoxides, phosphates and phosphoric acid.

In step (b) of the process of the invention, the mixture obtained from step (a) is dried convectively, i.e. liquids such as organic solvents and water are withdrawn and the mixture is mixed mechanically. The withdrawal of liquid can, for example, be brought about by application of a reduced pressure or preferably thermally. Mechanical mixing in step (b) can be effected, for example, by stirring, mixing in a rotary tube furnace or formation of a fluidized bed.

Examples of suitable apparatuses for step (b) are convective dryers, in particular paste milling dryers, milling dryers, flow dryers, cyclone dryers, ring dryers, carousel dryers, fluidized-bed dryers, fluidized-bed spray granulators, rotary tube dryers, convection belt dryers, mixer-dryers, shaft dryers, convection drying oven, flash dryers, spin-flash dryers and particularly preferably spray dryers. Examples of spray dryers are nozzle towers, disk towers and spray dryers having an integrated fluidized bed.

Step (b) is preferably carried out as atomization drying or spray drying. Spray drying can be carried out in a spray dryer, preferably in a drying tower, for example a nozzle tower, disk tower, spray dryer having an integrated fluidized bed. For this purpose, the mixture obtained in step (a) is, in one variant, pressed through one or more spray devices, for example through one or more nozzles or over an atomizer disk, into a hot air stream or a hot inert gas stream, with the hot gas stream or the hot inert gas stream being able to have a temperature in the range from 80 to 500° C., preferably from 90 to 400° C., particularly preferably from 120 to 340° C. In this way, the mixture is dried within fractions of a second to give a dry material which is preferably obtained as powder. The dry material can, for example, have a residual moisture content in the range from 0.5 to 10%, preferably from 1 to 8%, particularly preferably up to 5%.

In a preferred embodiment, the temperature of the hot air stream or the hot inert gas stream in step (b) is selected so that it is above the temperature in step (a).

In an embodiment of the present invention, the hot air stream or the hot inert gas stream flows in the same direction as the introduced mixture from step (a) (concurrent process). In another embodiment of the present invention, the hot air stream or hot inert gas stream flows in a direction counter to that of the introduced mixture from step (a) (countercurrent process). The spraying device is preferably located in the upper part of the spray dryer, in particular the spray tower.

The dry material obtained in step (b) can, after the actual spray drying, be separated off from the hot air stream or hot inert gas stream by means of a precipitator, for example a cyclone or a filter.

The dry material obtained in step (b) can, for example, have an average particle diameter (D50, weight average) in the range from 1 to 120 μm. Preference is given to the average particle diameter (D90, weight average) being up to 120 μm, particularly preferably up to 50 μm and very particularly preferably up to 20 μm.

Step (b) can be carried out batchwise (discontinuously) or continuously.

In the subsequent step (c), the dry material from step (b) is thermally treated at temperatures in the range from 350 to 1200° C., preferably from 400 to 1000° C., particularly preferably from 450 to 900° C.

In an embodiment of the present invention, the thermal treatment in step (c) is carried out in a temperature profile having from 2 to 5 stages, preferably 3 or 4 stages. For example, it is possible to set a temperature in the range from 350 to 550° C. in a first stage and a temperature in the range from 500 to 800° C. in a second stage, with the temperature in the latter being higher than in the first stage. If execution of a third stage is desired, the thermal treatment in the third stage can be carried out at from 700 to 1200° C., but in any case at a temperature which is higher than that in the second stage. These stages can, for example, be produced by setting of particular heating zones or, particularly when step (c) is to be carried out batchwise, by running a temperature-time profile.

The thermal treatment in step (c) can be carried out, for example, in a rotary kiln, a pendulum kiln, a muffle furnace, a roller hearth kiln (RHK), a fused silica bulb furnace, a continuous or batchwise calcinations furnace or in a push-through furnace.

The thermal treatment in step (c) can, for example, be carried out in a weakly oxidizing atmosphere, preferably in an inert or reducing atmosphere. For the purposes of the present invention, the term weakly oxidizing means that oxidants, for example small proportions of oxygen, are present in the atmosphere but in such small proportions that they are consumed by reducing agents (E). Examples of inert atmospheres are a noble gas atmosphere, in particular an argon atmosphere, and a nitrogen atmosphere. Examples of reducing atmospheres are nitrogen or noble gases comprising from 0.1 to 10% by volume of carbon monoxide or hydrogen. Further examples of reducing atmospheres are air or air enriched with nitrogen or with carbon dioxide, in each case comprising more mol % of carbon monoxide than oxygen.

In an embodiment of the present invention, step (c) can be carried out over a period in the range from 1 minute to 24 hours, preferably in the range from 10 minutes to 3 hours.

The process of the invention can be carried out without a high level of dust pollution. The process of the invention makes it possible to obtain electrode materials which have excellent rheological properties and are suitable as electrode materials and can be processed very well. For example, they can be processed to give pastes having good rheological properties.

The present invention further provides electrode materials comprising

(H) carbon in an electrically conductive modification and
(I) at least one compound of the general formula (I),

Liₓ(Fe_{1-y}M_{y})ₐSiO_{z} (I)

also referred to as transition metal compound (I) for short, where the variables are defined as follows:
M is selected from among transition metals and metals other than iron of the groups 3 to 13 of the Periodic Table of the Elements, preferably Sc, Al, Ti, V, Cr, Mn, Co, Ni, Cu and Zn, in particular Al, Mn, Ni and Co;
x is in the range from 0.1 to 4, preferably from 1 to 3, particularly preferably from 1.5 to 2.5;
y is in the range from 0 to 1, preferably at least 0.01;
z is in the range from 2 to 6, preferably from 3 to 5, particularly preferably from 2.5 to 4.5 and very particularly preferably 4;
a is in the range from 0.1 to 4, preferably from 0.2 to 2, particularly preferably from 0.5 to 1.5 and very particularly preferably 1;
   wherein carbon (H) and compound of the general formula (I) are present in the form of agglomerated particles,
   and carbon (H) is present in the pores of secondary particles of transition metal compound (I) or in the form of particles which can contact the particles of transition metal compound (I) at points, or as particles which contact one or more particles of carbon (H).

In an embodiment of the present invention, the variables in compound of the general formula (I) have the following meanings:

x is in the range from 1 to 3,
y is in the range from 0.01 to 1,
z is in the range from 3 to 5,
a is in the range from 0.2 to 2.0
and the remaining variables are as defined above.

In another embodiment of the present invention, the variables in the compound of the general formula (I) are selected as follows: x=2, y=0, a=1, z=4.

In another embodiment of the present invention, the variables in the compound of the general formula (I) are selected as follows: x=2, y=1, a=1, z=4 and M=Mn, Co, Ni, Cu or Zn, in particular Mn, Ni or Co.

Carbon in an electrically conductive modification (H), carbon for short, is, for example, carbon black, graphite, graphene, expanded graphites, carbides, carbon nanotubes or activated carbon.

In an embodiment of the present invention, electrically conductive, carbon-comprising material is carbon black. Carbon black can, for example, be selected from among lamp black, furnace black, flame black, thermal black, acetylene black and industrial black. Carbon black can comprise impurities, for example hydrocarbons, in particular aromatic hydrocarbons, or oxygen-comprising compounds or oxygen-comprising groups such as OH groups, epoxide groups, carboxyl groups and carbonyl groups. Furthermore, sulfur- or iron-comprising impurities are possible in carbon black.

In one variant, electrically conductive, carbon-comprising material is partially oxidized carbon black.

In an embodiment of the present invention, electrically conductive, carbon-comprising material is carbon nanotubes. Carbon nanotubes (CNTs for short), for example single-walled carbon nanotubes (SW CNTs) and preferably multi-walled carbon nanotubes (MW CNT), are known per se. A process for producing them and some properties are described, for example, by A. Jess et al. in Chemie Ingenieur Technik 2006, 78, 94-100.

In an embodiment of the present invention, carbon nanotubes have a diameter in the range from 0.4 to 50 nm, preferably from 1 to 25 nm.

In an embodiment of the present invention, carbon nanotubes have a length in the range from 10 nm to 1 mm, preferably from 100 nm to 500 nm,

Carbon nanotubes can be produced by processes known per se. For example, a volatile carbon-comprising compound such as methane or carbon monoxide, acetylene or ethylene or a mixture of volatile carbon-comprising compounds such as synthesis gas can be decomposed in the presence of one or more reducing agents such as hydrogen and/or a further gas such as nitrogen. Another suitable gas mixture is a mixture of carbon monoxide with ethylene. Suitable temperatures for the decomposition are, for example, in the range from 400 to 1000° C., preferably from 500 to 800° C. Suitable pressure conditions for the decomposition are, for example, in the range from atmospheric pressure to 100 bar, preferably up to 10 bar. Single- or multi-walled carbon nanotubes can be obtained, for example, by decomposition of carbon-comprising compounds in an electric arc, in the presence or absence of a decomposition catalyst.

In an embodiment, the decomposition of the volatile carbon-comprising compound or carbon-comprising compounds is carried out in the presence of a decomposition catalyst, for example Fe, Co or preferably Ni.

For the purposes of the present invention, the term graphene refers to virtually ideally or ideally two-dimensional hexagonal carbon crystals which have a structure analogous to single graphite layers.

In an embodiment of the present invention, the weight ratio of transition metal compound (I) to carbon (H) is in the range from 200:1 to 5:1, preferably from 100:1 to 10:1, particularly preferably from 100:1.5 to 20:1.

Carbon (H) is present in this case in the pores of secondary particles of compound of the general formula (I) or in the form of particles which can contact the particles of compound of the general formula (I) at points, or as particles which contact one or more particles of carbon (H).

This means that particles of transition metal compound (I) are coated neither completely nor partially with carbon (H). Instead, carbon (H) can, when transition metal compound (I) is present in the form of secondary particles comprising agglomerated primary particles, be incorporated in the pores of secondary particles of transition metal compound (I), but preferably not in the pores of primary particles of transition metal compound (I).

Preference is given to particles of transition metal compound (I) and of carbon (H) having no contact areas. Furthermore, particles of transition metal compound (I) and of carbon (H) also do not contact one another via edges.

Various particles of carbon (H) can contact (touch) one another via edges, points or areas or not at all.

Various particles of transition metal compound (I) can contact one another via edges, points, areas or not at all. In addition, various particles of transition metal compound (I) can penetrate into one another and/or be grown together to form agglomerates. Preference is given to various particles of transition metal compound (I) touching one another in agglomerates at least at points to form a sphere-like framework.

In an embodiment of the present invention, carbon (H) and transition metal compound (I) are present side-by-side in discrete particles which contact one another at points or not at all.

The above-described morphology of carbon (H) and transition metal compound (I) can be confirmed, for example, by optical microscopy, transmission electron microscopy (TEM) or scanning electron microscopy (SEM), and also, for example, X-ray crystallographically in the diffraction pattern.

In an embodiment of the present invention, primary particles of compound (I) have an average diameter in the range from 1 to 2000 nm, preferably from 10 to 1000 nm, particularly preferably from 50 to 500 nm. The average primary particle diameter can, for example, be determined by SEM or TEM.

In an embodiment of the present invention, transition metal compound (I) is present in the form of particles which have an average particle diameter in the range from 1 to 150 μm (d50) and can be present in the form of agglomerates (secondary particles). Preference is given to average particle diameters (d50) in the range from 2 to 50 μm, particularly preferably in the range from 4 to 30 μm.

In an embodiment of the present invention, carbon (H) has an average primary particle diameter in the range from 1 to 500 nm, preferably in the range from 2 to 100 nm, particularly preferably in the range from 3 to 50 nm, very particularly preferably in the range from 4 to 10 nm.

For the purposes of the present invention, particle diameters are preferably reported as volume averages, which can be determined, for example, by laser light scattering on dispersions.

In an embodiment of the present invention, a proportion of carbon or carbon (H) is present in the pores of particles of transition metal compound (I), in particular between primary particles of transition metal compound (I).

In an embodiment of the present invention, electrode material according to the invention additionally comprises at least one binder (J), for example a polymeric binder.

Suitable binders (J) are preferably selected from among organic (co)polymers. Suitable (co)polymers, i.e. homopolymers or copolymers, can, for example, be selected from among (co)polymers which can be obtained by anionic, catalytic or free-radical (co)polymerization, in particular from among polyethylene, polyacrylonitrile, polybutadiene, polystyrene, and copolymers of at least two comonomers selected from among ethylene, propylene, styrene, (meth)acrylonitrile and 1,3-butadiene. Polypropylene is also suitable. Furthermore, polyisoprene and polyacrylates are suitable. Particular preference is given to polyacrylonitrile.

For the purposes of the present invention, the term polyacrylonitrile encompasses not only polyacrylonitrile homopolymers but also copolymers of acrylonitrile with 1,3-butadiene or styrene. Preference is given to polyacrylonitrile homopolymers.

For the purposes of the present invention, the term polyethylene refers not only to homopolyethylene but also copolymers of ethylene which comprise at least 50 mol % of ethylene in copolymerized form and up to 50 mol % of at least one further comonomer, for example α-olefins such as propylene, butylene (1-butene), 1-hexene, 1-octene, 1-decene, 1-dodecene, 1-pentene, also isobutene, vinylaromatics such as styrene, also (meth)acrylic acid, vinyl acetate, vinyl propionate, C₁-C₁₀-alkyl esters of (meth)acrylic acid, in particular methyl acrylate, methyl methacrylate, ethyl acrylate, ethyl methacrylate, n-butyl acrylate, 2-ethylhexyl acrylate, n-butyl methacrylate, 2-ethylhexyl methacrylate, also maleic acid, maleic anhydride and itaconic anhydride. Polyethylene can be HDPE or LDPE.

For the purposes of the present invention, the term polypropylene refers not only to homopolypropylene but also to copolymers of propylene which comprise at least 50 mol % of propylene in copolymerized form and up to 50 mol % of at least one further comonomer, for example ethylene and α-olefins such as butylene, 1-hexene, 1-octene, 1-decene, 1-dodecene and 1-pentene. Polypropylene is preferably isotactic or essentially isotactic polypropylene.

For the purposes of the present invention, the term polystyrene refers not only to homopolymers of styrene but also to copolymers with acrylonitrile, 1,3-butadiene, (meth)acrylic acid, C₁-C₁₀-alkyl esters of (meth)acrylic acid, divinylbenzene, in particular 1,3-divinylbenzene, 1,2-diphenyl-ethylene and α-methylstyrene.

Another preferred binder (J) is polybutadiene.

Other suitable binders (J) are selected from among polyethylene oxide (PEO), cellulose, carboxymethylcellulose, polyimides and polyvinyl alcohol.

In an embodiment of the present invention, binders (J) are selected from (co)polymers which have an average molecular weight M_{w} in the range from 50 000 to 1 000 000 g/mol, preferably up to 500 000 g/mol.

Binders (J) can be crosslinked or uncrosslinked (co)polymers.

In a particularly preferred embodiment of the present invention, binders (J) are selected from among halogenated (co)polymers, in particular from among fluorinated (co)polymers. Here, halogenated or fluorinated (co)polymers are (co)polymers which comprise, in copolymerized form, at least one (co)monomer which has at least one halogen atom or at least one fluorine atom per molecule, preferably at least two halogen atoms or at least two fluorine atoms per molecule.

Examples are polyvinyl chloride, polyvinylidene chloride, polytetrafluoroethylene, polyvinylidene fluoride (PVdF), tetrafluoroethylene-hexafluoropropylene copolymers, vinylidene fluoride-hexafluoropropylene copolymers (PVdF-HFP), vinylidene fluoride-tetrafluoroethylene copolymers, perfluoro(alkyl vinyl ether) copolymers, ethylene-tetrafluoroethylene copolymers, vinylidene fluoride-chlorotrifluoroethylene copolymers and ethylene-chlorofluoroethylene copolymers.

Suitable binders (J) are, in particular, polyvinyl alcohol and halogenated (co)polymers, for example polyvinyl chloride or polyvinylidene chloride, in particular fluorinated (co)polymers such as polyvinyl fluoride and in particular polyvinylidene fluoride and polytetrafluoroethylene.

In an embodiment of the present invention, electrode material according to the invention comprises:

from 60 to 98% by weight, preferably from 70 to 96% by weight, of transition metal compound (I),
from 1 to 25% by weight, preferably from 2 to 20% by weight, of carbon (H),
from 1 to 20% by weight, preferably from 2 to 15% by weight, of binder (J).

Electrode materials according to the invention can readily be used for producing electrochemical cells. For example, they can be processed to give pastes having good rheological properties.

The present invention further provides electrochemical cells produced using at least one electrode according to the invention. The present invention further provides electrochemical cells comprising at least one electrode according to the invention.

A further aspect of the present invention is an electrode comprising at least one transition metal compound (I), carbon (H) and at least one binder (J).

Compound of the general formula (I), carbon (H) and binders (J) have been described above.

The geometry of electrodes according to the invention can be selected within wide limits. Electrodes according to the invention are preferably configured as thin films, for example films having a thickness in the range from 10 μm to 250 μm, preferably from 20 to 130 μm.

In an embodiment of the present invention, electrodes according to the invention comprise a foil/film, for example a metal foil, in particular an aluminum foil, or a polymer film, for example a polyester film, which can be untreated or siliconized.

The present invention further provides for the use of electrode materials according to the invention or electrodes according to the invention in electrochemical cells. The present invention further provides a process for producing electrochemical cells using electrode material according to the invention or electrodes according to the invention. The present invention further provides electrochemical cells comprising at least one electrode material according to the invention or at least one electrode according to the invention.

Electrodes according to the invention by definition serve as cathodes in electrochemical cells according to the invention. Electrochemical cells according to the invention comprise a counterelectrode which for the purposes of the present invention is defined as anode and can be, for example, a carbon anode, in particular a graphite anode, a lithium anode, a silicon anode or a lithium titanate anode.

Electrochemical cells according to the invention can be, for example, batteries or accumulators.

Electrochemical cells according to the invention can comprise not only an anode and an electrode according to the invention but also further constituents, for example electrolyte salt, nonaqueous solvent, separator, power outlet leads, for example leads made of metal or an alloy, also cable connections and housing.

In an embodiment of the present invention, electric cells according to the invention comprise at least one nonaqueous solvent which can be liquid or solid at room temperature, preferably selected from among polymers, cyclic or acyclic ethers, cyclic and acyclic acetals and cyclic or acyclic organic carbonates.

Examples of suitable polymers are, in particular, polyalkylene glycols, preferably poly-C₁-C₄-alkylene glycols and in particular polyethylene glycols. Here, polyethylene glycols can comprise up to 20 mol % of one or more C₁-C₄-alkylene glycols in copolymerized form. Polyalkylene glycols are preferably polyalkylene glycols capped with two methyl or ethyl groups.

The molecular weight M_{w} of suitable polyalkylene glycols and in particular of suitable polyethylene glycols can be at least 400 g/mol.

The molecular weight M_{w} of suitable polyalkylene glycols and in particular of suitable polyethylene glycols can be up to 5 000 000 g/mol, preferably up to 2 000 000 g/mol.

Examples of suitable acyclic ethers are, for example, diisopropyl ether, di-n-butyl ether, 1,2-dimethoxyethane, 1,2-diethoxyethane, with preference being given to 1,2-dimethoxyethane.

Examples of suitable cyclic ethers are tetrahydrofuran and 1,4-dioxane.

Examples of suitable acyclic acetals are, for example, dimethoxymethane, diethoxymethane, 1,1-dimethoxyethane and 1,1-diethoxyethane.

Examples of suitable cyclic acetals are 1,3-dioxane and in particular 1,3-dioxolane.

Examples of suitable acyclic organic carbonates are dimethyl carbonate, ethyl methyl carbonate and diethyl carbonate.

Examples of suitable cyclic organic carbonates are compounds of the general formulae (II) and (III)

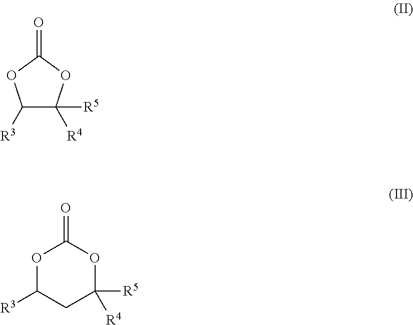

in which R³, R⁴ and R⁵ can be identical or different and are selected from among hydrogen and C₁-C₄-alkyl, for example methyl, ethyl, n-propyl, isopropyl, n-butyl, isobutyl, sec-butyl and tert-butyl, with preference being given to R⁴ and R⁵ not both being tert-butyl.

In particularly preferred embodiments, R³ is methyl and R⁴ and R⁵ are each hydrogen, or R⁵, R³ and R⁴ are each hydrogen.

Another preferred cyclic organic carbonate is vinylene carbonate, formula (IV).

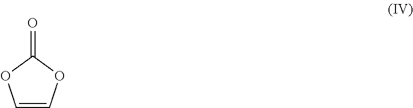

The solvent or solvents is/are preferably used in the “water-free” state, i.e. with a water content in the range from 1 ppm to 0.1% by weight, which can be determined, for example, by Karl-Fischer titration.

Electrochemical cells according to the invention further comprise at least one electrolyte salt. Suitable electrolyte salts are, in particular, lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CₙF₂ₙ₊₁SO₂)₂, where n is an integer in the range from 1 to 20, LiN(SO₂F)₂, Li₂SiF₆, LiSbF₆, LiAlCl₄, and salts of the general formula (CₙF₂ₙ₊₁SO₂)ₘYLi, where m is defined as follows:

m=1, when Y is selected from among oxygen and sulfur,
m=2, when Y is selected from among nitrogen and phosphorus, and
m=3, when Y is selected from among carbon and silicon.

Preferred electrolyte salts are selected from among LiC(CF₃SO₂)₃, LiN(CF₃SO₂)₂, LiPF₆, LiBF₄, LiClO₄, with particular preference being given to LiPF₆ and LiN(CF₃SO₂)₂.

In an embodiment of the present invention, electrochemical cells according to the invention comprise one or more separators by means of which the electrodes are mechanically separated. Suitable separators are polymer films, in particular porous polymer films, which are unreactive toward metallic lithium. Particularly suitable materials for separators are polyolefins, in particular porous polyethylene in the form of a film and porous polypropylene in the form of a film.

Separators composed of polyolefin, in particular polyethylene or polypropylene, can have a porosity in the range from 35 to 45%. Suitable pore diameters are, for example, in the range from 30 to 500 nm.

In another embodiment of the present invention, it is possible to use separators composed of PET nonwovens filled with inorganic particles. Such separators can have a porosity in the range from 40 to 55%. Suitable pore diameters are, for example, in the range from 80 to 750 nm.

Electrochemical cells according to the invention further comprise a housing which can have any shape, for example cuboidal or in the form of a cylindrical disk. In one variant, a metal foil configured as a bag is used as housing.

Electrochemical cells according to the invention produce a high voltage and have a high energy density and good stability.

Electrochemical cells according to the invention can be combined with one another, for example connected in series or connected in parallel. Connection in series is preferred.

The present invention further provides for the use of electrochemical cells according to the invention in appliances, in particular in mobile appliances. Examples of mobile appliances are vehicles, for example automobiles, two-wheeled vehicles, aircraft or water vehicles such as boats or ships. Other examples of mobile appliances are those which are moved by human beings, for example computers, in particular laptops, telephones or electrical hand tools, for example in the field of building, in particular drilling machines, screwdrivers powered by rechargeable batteries or tackers powdered by rechargeable batteries.

The use of electrochemical cells according to the invention in appliances offers the advantage of a relatively long running time before recharging. If the same running time were wanted when using electrochemical cells having a lower energy density, a higher weight of electrochemical cells would have to be accepted.

The invention is illustrated by examples.

### EXAMPLES

### I. Production of an Electrode Material

### Step (a.1)

### Starting Materials:

### (A.1): 357.4 g of FeOOH

(C.1): 350.4 g of LiOH.H₂O having a content of 57.4% by weight of LiOH
(B.1): 600.8 g of SiO₂ as 40% strength by weight colloidal solution in ammonia-comprising water, commercially available as Nexsil® 20 NH4
(D.1): 134.9 g of glucose

5.5 l of distilled water were firstly placed in a 10 liter double-walled stirred vessel provided with an anchor stirrer and heated to 70° C. The LiOH.H₂O(C.1) was subsequently dissolved therein and the iron compound (A.1) was then added. (B.1) was then added and rinsed in with half a liter of water. The mixture was heated while stirring to 90° C. and stirred at 90° C. for one hour (pH=11.45). This gave a suspension comprising LiOH, FeOOH, glucose and SiO₂ and also primary reaction products.

### Step (b.1)

5.5 l of the suspension from step (a.1) was sprayed in air in a spraying tower from Niro according to a program. The hot air stream had a temperature of 330° C. at the inlet and 110° C. at the outlet. The 5.5 l of suspension was sprayed over a period of 2 hours.

A yellow powder was obtained.

### Step (c.1)

The powder from step (b.1) was thermally treated at 700° C. under an N₂ atmosphere in a laboratory rotary tube furnace operated batchwise at 10 revolutions per minute. The treatment time was one hour. After the thermal treatment was complete, the product was allowed to cool to room temperature. This gave electrode material according to the invention comprising transition metal compound (I.1) and carbon (H.1). Carbon (H.1) and transition metal compound (I.1) were, as could be shown by SEM, present in discrete particles and the particles of carbon (H.1) and transition metal compound (I.1) either did not touch or in each case touched only at a single point. Particles of carbon (H.1) touch one another in any way; particles of transition metal compound (I.1) were present separately.

### II. Production of Electrochemical Cells According to the Invention

Electrode material according to the invention can be processed as follows with a binder (J), for example with binder (J.1): copolymer of vinylidene fluoride and hexafluoropropene, as powder, commercially available as Kynar Flex® 2801 from Arkema, Inc.

To determine the electrochemical data of the electrode materials, 8 g of electrode material according to the invention from step (c.1) and 1 g of (J.1) are mixed to a paste with addition of 1 g of N-methylpyrrolidone (NMP). A 30 μm thick aluminum foil is coated with the above-described paste (active material loading: 5-7 mg/cm²). After drying, at 105° C., circular pieces of the resulting coated aluminum foil (diameter: 20 mm) are stamped out and used to form electrochemical test cells. A 1 mol/l solution of LiPF₆ in ethylene carbonate/dimethyl carbonate (mass ratio=1:1) is used as electrolyte. The anode of the test cells comprises a lithium foil which is in contact with the cathode foil via a separator made of glass fiber paper.

Electrochemical cells EZ.1 according to the invention are obtained.

When electrochemical cells according to the invention are cycled (charged/discharged) between 4 V and 2.5 V at 25° C. in 100 cycles and when charging and discharging currents are 140 mA/g of cathode material, retention of the discharging capacity after 100 cycles can be determined.

Electrochemical cells EZ.1 according to the invention display a good cycling stability.

1. A process for producing electrode materials, wherein
(a) (A) iron or at least one iron compound in which Fe is present in the oxidation state zero, +2 or +3,
(B) silicon or at least one silicon compound selected from among silicon halides, silicon carbide, SiO, silica gels, silicic acid and silanes having at least one alkyl group or at least one alkoxy group per molecule,
(C) at least one lithium compound,
(D) at least one carbon source which can be a separate carbon source or at the same time at least one iron compound (A) or silicon compound (B) or lithium compound (C),
(E) optionally at least one reducing agent,
(F) optionally at least one compound which has a transition metal or metal other than iron of groups 3 to 13 of the Periodic Table of the Elements,
(G) optionally water or at least one organic solvent, are mixed with one another,
(b) the mixture thus obtained is dried convectively and
(c) thermally treated at temperatures in the range from 400 to 1200° C.

2. The process according to claim 1, wherein the carbon source (D) is selected from among activated carbon, carbon black, silicon carbide, organic polymers and graphite.

3. The process according to either of claims 1 and 2, wherein iron compound (A) is selected from among FeOOH, Fe₂O₃, Fe₃O₄, iron acetate, iron citrate, iron lactate and iron carbonate.

4. The process according to any of claims 1 to 3, wherein lithium compound (C) is selected from among LiOH, Li₂CO₃, Li₂O, LiNO₃, Li₂SO₄ and Li silicates.

5. The process according to any of claims 1 to 4, wherein silicon compound (B) is selected from among Si(OR¹)₄, where the radicals R¹ can be identical or different and are selected from among phenyl and C₁-C₁₀-alkyl.

6. The process according to any of claims 1 to 4, wherein silicon compound (B) is selected from among SiO, SiC, SiO₂ gels and SiO₂ colloids.

7. The process according to any of claims 1 to 6, wherein the thermal treatment in step (c) is carried out in an inert atmosphere or a reducing atmosphere.

8. The process according to any of claims 1 to 7, wherein compound (F) is selected from compounds of Al, Ti, V, Cr, Mn, Co, Ni, Cu and Zn.

9. The process according to any of claims 1 to 8, wherein step (b) is carried out as spray drying.

10. An electrode material comprising
(H) carbon in an electrically conductive modification and
(I) at least one compound of the general formula (I),
Liₓ(Fe_{1-y}M_{y})ₐSiO_{z} (I)
where the variables are defined as follows:
M is selected from among transition metals and metals other than iron of the groups 3 to 13 of the Periodic Table of the Elements,
x is in the range from 0.1 to 4,
y is in the range from 0 to 1,
z is in the range from 2 to 6,
a is in the range from 0.1 to 4,
wherein carbon (H) and compound of the general formula (I) are present in the form of agglomerated particles, where
carbon (H) is present in the pores of secondary particles of compound of the general formula (I) or in the form of particles which can contact particles of compound of the general formula (I) at points or as particles which contact one or more particles of carbon (H).

11. The electrode material according to claim 10, wherein the variables are selected as follows:
x is in the range from 1 to 3,
y is at least 0.01,
z is in the range from 3 to 5,
a is in the range from 0.2 to 2,
and the remaining variables are as defined above.

12. The electrode material according to claim 10 or 11, wherein M is selected from among Al, Sc, Ti, V, Cr, Mn, Co, Ni, Cu and Zn.

13. The electrode material according to any of claims 10 to 12, wherein carbon (H) has an average particle diameter in the range from 1 to 500 nm.

14. The electrode material according to any of claims 10 to 13, wherein the compound of the general formula (I) is present in the form of particles which can be present in agglomerates and have an average particle diameter in the range from 1 to 150 μm (d50).

15. The use of electrode materials according to any of claims 10 to 14 for producing electrochemical cells.

16. An electrochemical cell comprising at least one electrode material according to any of claims 10 to 14.

17. The use of electrochemical cells according to claim 16 in appliances.
